(19) United States
(12) Patent Application Publication
(10) Pub. No.: US 2008/0132428 A1
(43) Pub. Date: Jun. 5, 2008

(54) Oil-immersion, soft-print array replication

(76) Inventors: Edward C. Cox, Princeton, NJ (US); Roy J. Rosser, Princeton, NJ (US)

Correspondence Address: MRM, LLC, 56 MALDENHEAD ROAD, PRINCETON, NJ, 08540, US

(21) Appl. No.: 11/950,298

(22) Filed: Dec. 4, 2007

Related U.S. Application Data
(60) Provisional application No. 60/868,489, filed on Dec. 4, 2006.

(51) Int. Cl. C40B 50/06

(52) U.S. Cl. 506/26

(57) ABSTRACT

A method of replicating a DNA microarray in which a multi-drop transfer plate is loaded with PCR master-mix and then moved into close proximity with a master array so that a portion of the PCR master mix is transferred to the master array. The master array is immersed in oil so that complementary DNA may be produced by one or more steps of a PCR reaction. A replica substrate loaded with water drops is then brought into close proximity with the master array so that a portion of complementary DNA is transferred onto the replica substrate. After cleaning any residual oil from replica substrate, it is ready for use.

### CROSS REFERENCE TO RELATED APPLICATIONS

This application is related to, and claims priority from, U.S. Provisional Patent application no. 60/868,489 filed on Dec. 4, 2006 by Rosser et al entitled “Oil-immersion, soft-print microarray replication with PCR replenishment”, the entire contents of which are hereby incorporated by reference.

### FIELD OF THE INVENTION

The present invention relates to nucleic acid microarrays, and more particularly to methods and apparatus for replicating DNA microarrays.

### BACKGROUND OF THE INVENTION

A DNA microarray (also commonly known as gene chip, DNA chip, or biochip) is a collection of microscopic DNA spots attached to a solid surface, such as glass, plastic or silicon chip forming an array. Over the last decade, they have become widely used to measure the expression levels of large numbers of genes simultaneously. Measuring gene expression using microarrays is relevant to many areas of biology and medicine, such as studying treatments, disease, and developmental stages.

In gene expression analysis, the mRNA, which is indicative of which genes are active in a cell, is extracted from a tissue sample, then converted to DNA. Fluorescent tags are attached to the newly synthesized DNA. A DNA molecule that contains a sequence complementary to one of the single-stranded probe sequences on the array will hybridize to the spot at which that complementary strand is affixed. The spot will then fluoresce when examined using a microarray scanner. The fluorescence intensity of each spot is indicative of the number of copies of a particular mRNA, which ideally indicates the level of expression of a particular gene.

By giving information on the levels of gene expression of thousands of genes at the same time, DNA microarrays allow researchers to relate the effect of a disease to particular genes. Much current medical research is focused on finding gene expression signatures for various diseases. Once these gene expression signatures are known, microarrays will become used in clinical medicine as diagnostics tests for early stage detection of a variety of diseases, including cancers, cardiovascular disease and diabetes, as well as providing methods of classifying, managing and treating those diseases. It has also been suggested that circulating leukocytes in the blood can be viewed as scouts, continuously maintaining a vigilant and comprehensive surveillance of the body for signs of infection or other threats, including cancer. Preliminary studies have already shown that peripheral blood can be used to develop a gene-expression-based test for early detection of breast cancer.

Currently, total annual production of commercial microarrays is roughly 1 m chips. According to the National Center for Health Statistics, there are 1 billion doctor-visits each year in the USA. If at each visit, a microarray diagnostic was used, annual production of microarrays would need to be ramped up by a factor of 10,000. (As up to 3 microarrays per test are often used to provide gene copy redundancy, the necessary increase in production could be higher). Even if the cost of the microarrays is reduced by a factor of 10 from their current cost, the total annual U.S. microarray market would be $25 billion. Alternatively, if every one of the 84% of the population that visits a doctor one or more times a year gets one microarray test each year, 250 million microarrays would be needed annually in the US. For microarray tests to become routine clinical tests, a significant increase in production is required, necessitating new methods of volume production.

Microarrays can be fabricated using a variety of technologies, including spotting (printing with industrial robots using fine-pointed pins onto glass slides), photolithography using pre-made masks, photolithography using dynamic micro-mirror devices, ink-jet printing of oligimers and synthesis on chip using ink jet dispensing of reagents.

In addition to these fabrication methods, there have been proposals to replicate micro-arrays from a master array. The reason for this interest in replicating arrays is a possible factor of 20 improvement in volume production that should lead to significant price reductions, possibly reducing the cost of microarrays by 90% or more.

Prior attempts at microarray replication have, however, been unsuccessful because they require direct contact between the master array and the replica substrate, necessitating unreliable, deformable surfaces or solid surface accuracies of <0.05 μm. This is an extremely tight and costly tolerance.

There have also been proposals to use proximity printing to replicate microarrays using electrical currents to transfer the replica product across a narrow gap. Such arrangements, however, either require additional electrodes on the microarray or unrealistically high electrical fields.

### SUMMARY OF THE INVENTION

Briefly described, the invention provides a method of replicating a DNA microarray.

In one embodiment, the method includes filling a multi-drop transfer plate with PCR master-mix and then moving the filled multi-drop transfer plate into close proximity with a master array so that a portion of the PCR master mix is transferred to the master array. The master array is then immersed in oil so that complementary DNA may be produced by one or more steps of a PCR reaction. A replica substrate loaded with water drops is then brought into close proximity with the master array so that a portion of complementary DNA is transferred onto the replica substrate. After cleaning any residual oil from replica substrate, it is ready for use.

These and other features of the invention will be more fully understood by references to the following drawings.

### BRIEF DESCRIPTION OF THE DRAWINGS

FIG. 1 shows a plan view of a master array.

FIG. 2 shows a side elevation of a master array.

FIG. 3 shows a schematic elevation view of a master array loaded with drops of PCR master mix.

FIG. 4A shows a plurality of water drops arrayed on a replica substrate

FIG. 4B shows the replica substrate brought in close proximity to the master array.

FIG. 4C show a loaded replica array being withdrawn.

FIG. 5 shows a schematic side view of a multi-drop transfer plate.

FIG. 6A. shows the multi-drop transfer plate filled with PCR master-mix aligned with master array.

FIG. 6B shows a filled multi-drop transfer plate in close proximity to a master array.

FIG. 6C shows the PCR master mix being soft printed onto a master array.

FIG. 6D shows the master array placed in an oil immersion chamber.

FIG. 6E shows complementary DNA being produced by a PCR reaction.

FIG. 6F shows a replica substrate loaded with a plurality of water drops aligned with a master array.

FIG. 6G shows a replica substrate being brought into close proximity with a master array.

FIG. 6H shows complementary DNA 44 being soft printed onto a replica substrate 24.

FIG. 6I shows a replica microarray cleaned of oil, ready for use.

FIG. 7A shows a transfer plate substrate covered with a hydrophilic layer.

FIG. 7C shows a micron scale multi-drop transfer plate.

FIG. 8 is a schematic elevation view of a system for loading a multi-drop transfer plate.

FIG. 9 is a schematic elevation view of an exemplary embodiment of the present invention for loading a multi-drop transfer plate 30 with a water-based reagent

FIG. 10 is a schematic elevation view of a further exemplary embodiment of the present invention for loading a multi-drop transfer plate with a reagent.

FIG. 11 is a schematic elevation view of another exemplary embodiment of the present invention for loading a multi-drop transfer system with a reagent.

### DETAILED DESCRIPTION

The present invention applies to the replication of micro-arrays, particularly nucleic acid microarrays.

Systems and methods for replicating have been described in, for instance, PCT patent application no. PCT/US2005/042800 filed on Nov. 28, 2005 by Rosser entitled “System and Method for Replicating a Bio-molecular microarray” that was published as PCT publication WO/2006/058246 on Jun. 1, 2006, the contents of which are hereby incorporated by reference in their entirety.

Systems and methods for replicating have been described in, for instance, Cantor's U.S. Pat. No. 5,795,714 filed on Aug. 18, 1998 entitled “Method for replicating an array of nucleic acid probes” and Church's U.S. Pat. No. 6,432,360 filed on Aug. 13, 2002 entitled “Replica amplification of nucleic acid arrays”, the contents of both of which are hereby incorporated by reference.

A preferred embodiment of the invention will now be described in detail by reference to the accompanying drawings in which, as far as possible, like elements are designated by like numbers.

Although every reasonable attempt is made in the accompanying drawings to represent the various elements of the embodiments in relative scale, it is not always possible to do so with the limitations of two-dimensional paper. Accordingly, in order to properly represent the relationships of various features among each other in the depicted embodiments and to properly demonstrate the invention in a reasonably simplified fashion, it is necessary at times to deviate from absolute scale in the attached drawings. However, one of ordinary skill in the art would fully appreciate and acknowledge any such scale deviations as not limiting the enablement of the disclosed embodiments.

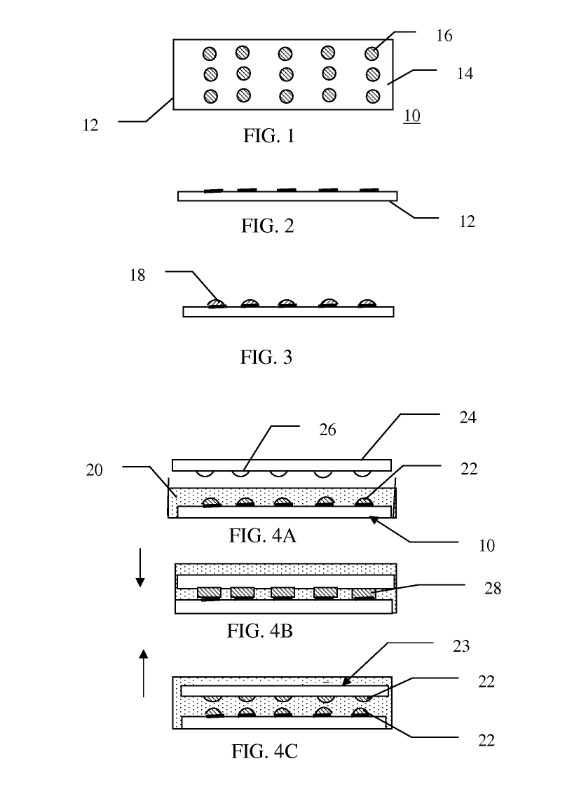

FIG. 1 shows a plan view of a master array 10 in which a nucleic acid is tethered in spots on a master array substrate 12, resulting in discrete regions of tethered DNA 16. The discrete regions of tethered DNA 16 may simply be discrete regions where the DNA has been spotted, or they may be hydrophilic areas patterned on an otherwise hydrophobic master array substrate 12 or master array upper surface 14.

FIG. 2 shows a side elevation of the master array 10

FIG. 3 shows a schematic elevation view of the master array 10 loaded with drops of PCR master mix 18, ready for the PCR stage of the soft-print microarray replication with PCR replenishment. A PCR reaction involves cycling the reagents through three temperatures. A typical PCR protocol is an initial cycle of denaturing for 1 minute at 95° C., followed by 40 cycles of denaturation: 1 minute at 95° C.; annealing: 1 minute at 50° C. and extension: 1 minute at 72° C., with a final extension of 10 minutes at 72° C. Even though our process only envisages one to three PCR cycles with no final extension, a concern is preventing the evaporation of the microdrops. In principle, the evaporation could be prevented by performing the PCR at a significantly elevated pressure in a saturated atmosphere. As the boiling point of water is raised to about 150° C. at 10 atmosphere pressure, which is easily reached with a pressurized nitrogen cylinder and a well designed chamber. A more elegant solution, however, is to cover the loaded microarray with a thin layer of mineral oil.

FIG. 4 shows the oil-immersion soft-printing strategy.

FIG. 4A shows a plurality of water drops 26 arrayed on a replica substrate 24. The master array 10 is immersed in oil 20 and contains drops of water containing PCR product 22.

FIG. 4B shows the replica substrate 24 brought in close proximity to the master array 10. The water drops 26 fuse and the PCR product 22 mixes through convection.

FIG. 4C show a loaded replica array 23 being withdrawn. The water drops on the loaded replica array 23 now contain approximately half the PCR reaction product 22. This PCR product 22 can be attached to the replica array surface and the oil layer cleaned off by, for instance, washing in ethanol.

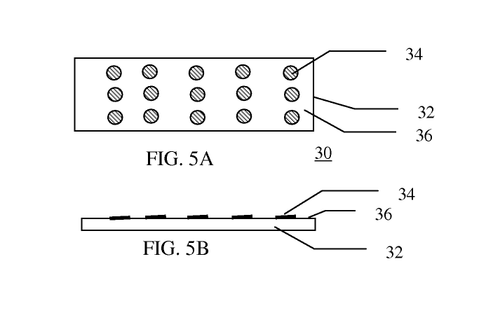

FIG. 5A shows a schematic plan view of a multi-drop transfer plate 30 comprised of a transfer plate substrate 32 having a hydrophobic surface 36 patterned with hydrophilic islands 34. The islands may be loaded with reagents by dipping into a vat of water in which the reagents are dissolved. In one embodiment, the multi-drop transfer plate 30 was made using glass microscope slides as the transfer plate substrate 32 coated with Teflon™ to produce the hydrophobic surface 36 and patterned with 192 1.5 mm diameter wells. The slides were purchased from Tekdon Inc., Florida. As the Teflon coating is placed on the slides by a silk screen process, 1.5 mm diameter is, according to the manufacturers, the minimum diameter that can be produced reliably by such a method.

FIG. 5A shows a schematic side view of a multi-drop transfer plate 30.

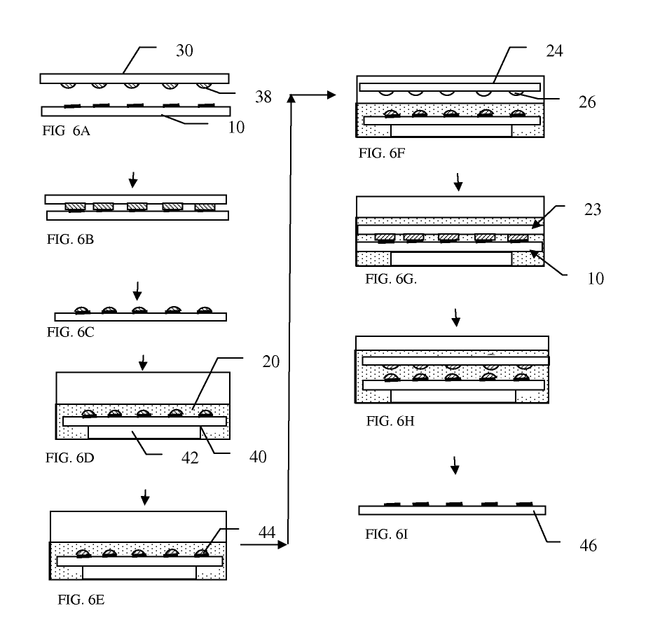

FIGS. 6A to 6I show steps of one preferred embodiment of performing oil-immersion soft print microarray replication.

FIG. 6A. shows the multi-drop transfer plate 30 filled with PCR master-mix 38 aligned with master array 10.

FIG. 6B shows a filled multi-drop transfer plate 30 being bought into close proximity with the master array 10.

FIG. 6C shows the PCR master mix 38 being soft printed onto a master array 10.

FIG. 6D shows the master array 10 placed in an oil immersion chamber 40 on a heating element 42.

FIG. 6E shows complementary DNA 44 being produced by a PCR reaction.

FIG. 6F shows a replica substrate 24 loaded with plurality of water drops 26 aligned with the master array 10.

FIG. 6G shows the replica substrate 24 being brought into close proximity with the master array 10.

FIG. 6H shows the complementary DNA 44 being soft printed onto the replica substrate 24.

FIG. 6I show the replica microarray 46 cleaned of oil, ready for use.

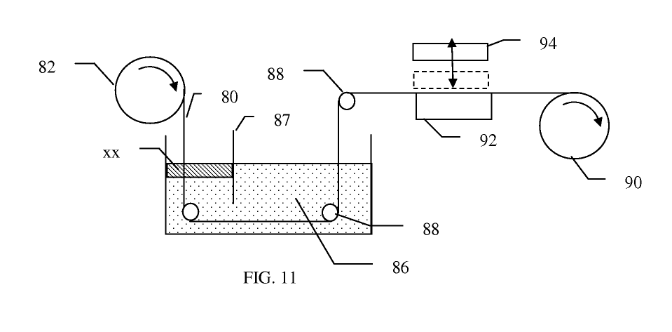

A micron scale multi-drop transfer plate requires a process that can produce an array of thousands of 10-100 μm diameter hydrophilic wells on a flat hydrophobic substrate. FIG. 11 shows a proposed method of fabricating such a μm scale multi-drop transfer plate.

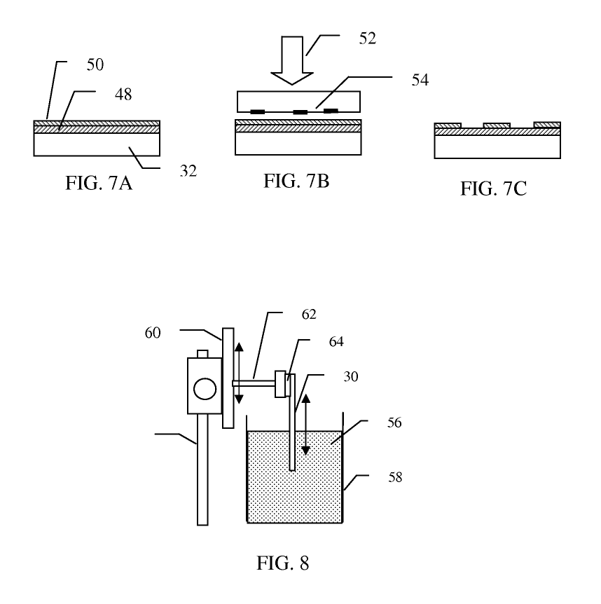

FIG. 7A shows a transfer plate substrate 32 covered with a suitably hydrophilic layer 48 that is eximer laser ablatable. A standard glass microscope slide, for instance, has the required surface flatness and roughness to be a good substrate. The top surface of the hydrophilic layer 48 is then made hydrophobic by chemical coating or adding a thin hydrophobic layer 50. PMMA is a good hydrophilic layer 48 as it can be directly photoablated using 192 nm λ radiation, has a water-wetting angle in range of 75 degrees, and is easily spin coated onto glass at controllable thickness of the order of microns. This high water wetting angle will allow more than half of each drop attached to be to the transfer plate to be transferred to the master array which will have a hydrophilic surface with wetting angle in the range of 30-50 degrees. PMMA is also resistant to heptane, allowing the hydrophobic surface to be created by dipping in a solution of chlorinated organopolysiloxane in heptane (Sigmacote from Sigma Chemicals). The Sigmacoted surface is hydrophilic with a wetting angle of approximately 110 degrees and is essentially transparent to the 192 nm λ radiation.

FIG. 7B shows an Eximer laser 52 being used to directly pattern the PMMA by photo-ablation through a photo-mask 54. The photo-mask 54 may, for instance, be a gold-on-quartz photo-mask made by the standard photolithography techniques used in the semiconductor industry or by direct laser writing. The photo-mask 54 may have a pattern that is essentially identical to the required pattern on the transfer plate such as, for instance, an array of circular wells.

FIG. 7C shows the finished micron scale multi-drop transfer plate 30. The PMMA is only partially photo-ablated so that the siloxane coating is removed but PMMA remains.

FIG. 8 is a schematic elevation view of a system for loading a multi-drop transfer plate 30 with a water-based reagent 56. The water-based reagent 56 is contained in a reagent vat 58. The reagent vat 58 is deep enough to allow the multi-drop transfer plate 30 to be dipped vertically far enough into the water-based reagent 56 that all the hydrophilic wells 34 to be filled may be submerged. When the multi-drop transfer plate 30 is subsequently withdrawn from the water-based reagent 56, all the hydrophilic wells 34 that were submerged in the water-based reagent 56 will be loaded with a drop of reagent. Having the multi-drop transfer plate 30 held substantially vertical when being withdrawn from the water-based reagent 564 is an effective way of uniformly filling the hydrophilic wells 34 of the multi-drop transfer plate 30.

The lowering of the multi-drop transfer plate 30 into, and the subsequent withdrawal of the multi-drop transfer plate 30 out of the water-based reagent 56 in the reagent vat 58 may, for instance, be controlled by a rack and pinion translator 60. The multi-drop transfer plate 30 may, for instance, be removably attached to a metal bracket 62 by a magnetic strip 64 that is glued or otherwise adhered to the multi-drop transfer plate 30.

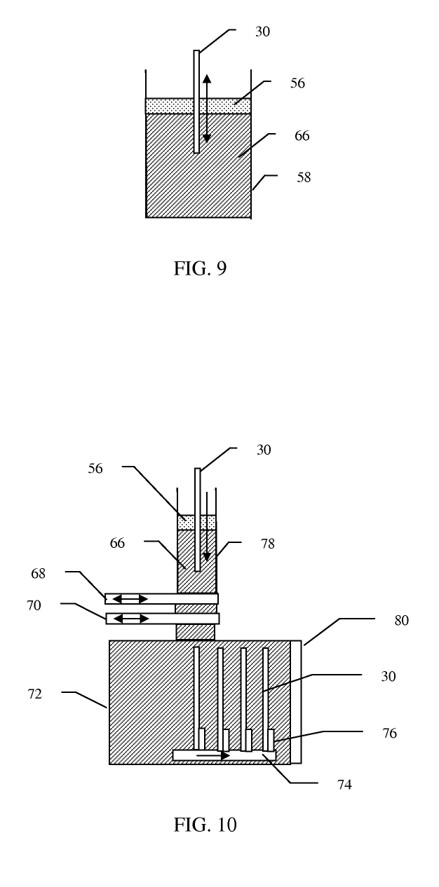

FIG. 9 is a schematic elevation view of an exemplary embodiment of the present invention for loading a multi-drop transfer plate 30 with a water-based reagent 56.

In a preferred embodiment, a thin layer of water-based reagent 56 is floated on top of a dense, non-aqueous phase liquid (DNAPL) 66, such as, but not limited to, trichloroethylene or tetrachloroethylene. The thin layer of water-based reagent 56 is at least as thick as the length of the hydrophilic wells 34 on the multi-drop transfer plate 30. The DNAPL 56 is preferably sufficiently deep to allow a vertically held multi-drop transfer plate 30 to be lowered until all the hydrophilic wells 34 to be filled have passed into or through the thin layer of water-based reagent 56.

The water-based reagent 56 may, for instance, be a Polymerase Chain Reaction (PCR) master mix of nucleotides (dNTPs) of the four bases in DNA and a primer that is a short, single stranded DNA molecule, typically of the order of a 20mer, in a pH buffering solution. The water-based reagent 56 has a specific gravity that is substantially 1, while the DNAPL 66 has a specific gravity that is greater than 1. The DNAPL 26 may for instance be, but is not limited to, trichloroethylene or tetrachloroethylene.

Trichloroethylene is a chlorinated hydrocarbon commonly used as an industrial solvent. Trichloroethylene is a colorless liquid with a boiling point of 87° C. and a specific density of 1.46 and a solubility in water of only 1 g/L.

Tetrachloroethylene is a manufactured chemical compound that is widely used for the dry cleaning of fabrics and for metal-degreasing. Tetrachloroethylene is also known as perchloroethylene, perc, PCE, and tetrachloroethene. It is a nonflammable liquid at room temperature that evaporates easily into the air and has a sharp, sweet odor Tetrachloroethylene has a specific density of 1.62, a solubility in water of only 0.015 g/100 ml (20° C.) and a boiling point of 121.1° C.

FIG. 10 is a schematic elevation view of a further exemplary embodiment of the present invention for loading a multi-drop transfer plate with a reagent.

The multi-drop transfer plate 30 is dropped through the layer of water-based reagent 56 floating on top of the DNAPL 66. A first flat valve 68 and a second flat valve 70 are initially both open, allowing the multi-drop transfer plate 30 to decend into a large, removable vat 72. The large, removable vat 72 may also filled with DNAPL 66. The large, removable vat 72 may also contain a movable rack 74. The movable rack 74 may be positioned to receive the multi-drop transfer plate 30 as it descends into the large, removable vat 72. The movable rack 74 may also have supports 76 to keep the multi-drop transfer plates 30 upright. Once the movable rack 74 is fill with multi-drop transfer plates 30 that have been filled with drops of reagent 56, the first flat valve 68 and the second flat valve 70 may be closed. The first flat valve 68 is attached to the reagent vat 78 while the second flat valve 70 is attached to the large, removable vat 72. When the valves are closed, the large, removable vat 72 may be removed from reagent vat 78. The large, removable vat 72 may then be turned so that the openable lid 80 is substantially horizontal and above the large, removable vat 72. The openable lid 80 may then be opened and the movable rack 74 containing the loaded multi-drop transfer plates 30 removed.

FIG. 11 is a schematic elevation view of another exemplary embodiment of the present invention for loading a multi-drop transfer system with a reagent.

A flexible patterned substrate 80 is feed from a first spool 82 through a layer of reagent to be loaded 84 into a higher density liquid 86 on which the reagent to be loaded 84 is floating. The flexible patterned substrate 80 is feed by a series of rollers 88 to an uptake reel 90. The flexible patterned substrate 80 loaded with reagent to be loaded 84 may pass over a support 94. The support 94 may allow the loaded flexible patterned substrate 80 to be brought into contact with a transfer substrate 94.

Although the detailed description above has focused on a water based reagent floating on an oil, it would be obvious to one of ordinary skill the art the reagent to be loaded 84 may be an oil based reagent floated on a higher density liquid 86 that may for instance be water. In such a case, the flexible patterned substrate 80 may have hydrophobic islands surrounded by hydrophilic barriers. For instance, the bistable electrowetting display devices described in, for instance, U.S. provisional patent 60/894,210 filed on Mar. 10, 2007 by Rosser entitled “Bistable Electrowetting Display Device”, or U.S. provisional patent 60/943,752 filed on Jun. 13, 2007 by Rosser entitled “Bi-stable, soft-print electrowetting light valve and display”, the contents of both of which are hereby incorporated by reference, could have their pixels filled by one or more of the methods described above.

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention. Modifications may readily be devised by those ordinarily skilled in the art without departing from the spirit or scope of the present invention.

What is claimed is:

1. A method of replicating a DNA microarray, said method comprising:
filling a multi-drop transfer plate with PCR master-mix;
moving said filled multi-drop transfer plate proximate to a master array, thereby transferring a portion of said PCR master mix to said master array;
immersing said master array in oil;
producing complementary DNA by one or more steps of a PCR reaction; and
bringing a replica substrate loaded with a plurality of water drops proximate to said master array containing said complementary DNA thereby transferring a portion of said complementary DNA onto said replica substrate.

2. The method of claim 1 further comprising cleaning oil from said replica substrate.

3. A method for loading one or more discrete volumes of a first liquid onto a substrate, said method comprising:
providing said substrate with a first surface having an affinity to said first liquid;
partitioning said first surface of said substrate using a material having an aversion to said first liquid; and
passing said partitioned substrate through said first liquid.

4. The method of claim 3 further comprising:
floating a layer of said first liquid on top of a second liquid;
and wherein said step of passing occurs while said first liquid is floating on said second liquid.

5. The method of claim 4 wherein said first surface is hydrophilic and said portioning material is hydrophobic.

6. The method of claim 3 wherein portioning results in a multiplicity of essentially equally sized regions of said first surface being exposed to said first liquid.

7. The method of claim 4 wherein said first surface is hydrophobic and said portioning material is hydrophilic.
